(19) United States
(12) Patent Application Publication
(10) Pub. No.: US 2024/0083682 A1
(43) Pub. Date: Mar. 14, 2024

(54) A 2-PASS CONVEYOR SYSTEM WITH TILTABLE TRAYS

(71) Applicant: SRINATH GUDDANAHALLI SREENIVAS, Bangalore (IN)

(72) Inventor: SRINATH GUDDANAHALLI SREENIVAS, Bangalore (IN)

(21) Appl. No.: 17/768,105

(22) PCT Filed: Oct. 13, 2020
(86) PCT No.: PCT/IB2020/059606

§ 371 Date: Apr. 11, 2022

(30) Foreign Application Priority Data
Oct. 13, 2019 (IN) 201941024667
Feb. 5, 2020 (IN) 202041005001
Jun. 25, 2020 (IN) 202041027084

(51) Int. Cl. B65G 17/06; A23B 9/08; B65G 47/96

(52) U.S. Cl. CPC B65G 17/067; A23B 9/08; B65G 47/967

(57) ABSTRACT

The present disclosure relates to a conveyor system (100) that provides a rigid flatbed which forms a continuous bed surface comprising tilt-able segmental trays (2) for two-pass capability. The conveyor system (100) is capable of utilizing the upper and lower run of the conveyor simultaneously for transportation of the material thereby reducing the area of the equipment of which the conveyor forms a part of. And the conveyor is rigid enough to support simultaneous processing of the produce it carries like drying, heating etc.

### FIELD OF THE INVENTION

The present invention relates generally to the field of agricultural equipment. More specifically, the invention relates to the field of conveyors for use in driers for conveying the grains/agriculture produce for processing. More specifically this invention is a new concept of a compact conveyor capable of grain movement in a way to be able to process-on-the-move for parallel drying & other related heat treatment process, including application of vacuum, resulting in a compactness of the dryer by as much as 90% compared to the contemporary forced convectional dryers currently in use.

### BACKGROUND OF THE INVENTION

Agriculture produce drying is the process of drying agriculture produces to prevent spoilage during storage. There are various existing techniques in prior art that are used for agriculture produce drying. One such technique of drying involves drying under sunlight over a vast patch of prepared land. This technique involves a labor-intensive process utilizing either manual or semi-mechanized means to spread out and subsequently gather back the agriculture produce to and from the open-air drying areas. This is particularly stressful to the workers especially in adverse weather conditions normally found during drying seasons.

A conveyor belt is the carrying channel of a belt conveyor system. A belt conveyor system is one of the many types of conveyor systems. A belt conveyor system comprises of two or more pulleys, with an endless loop of the conveyor belt that rotates about them. One or both of the pulleys are powered, moving the belt and the material on the belt forward. The powered pulley is known as drive pulley while the unpowered pulley is named as idler pulley. The industrial classes of belt conveyors is mainly classified in general material handling and agricultural materials such as grain, salt, coal, ore, sand and more.

Grain drying process is accomplished to prevent spoilage of agricultural grains during their storage. Grains such as wheat, corn, soybean, rice and other grains as sorghum, sunflower seeds, rapeseed, barley, oats seeds are dried in grain dryers in hundreds of millions of tons. A grain drying equipment uses fuel or electric-powered source for functioning. Aeration, unheated or natural grain drying, deration, in-storage cooling, heated air grain drying, solar drying, etc. are some of the conventional methods adapted for drying of grains. Grain Dryers consists of three types: Bin, Batch and Continuous flow.

The conventionally used drier equipment are bulky in construction and need huge amount of space, as generally, the grains need to be dried in bulk. It may not be feasible to set up such drier equipment in a huge space, as these cannot be set up in congested areas, with space constraints. Further, management and maintenance of such bulky and overspread equipment requires a lot of efforts, involve huge costs of setting up and maintenance, require a lot of human intervention, thereby leading to hiring more manpower, thereby leading to extra costs.

Other common design of conveyors comprises a flexible belt using PU or rubber material and this makes it difficult to offer a continuous surface and rigid flat base strong enough to support flat surfaces or heavier loads. Normally a series of conveyors are used to transfer the grains over large distances to accommodate higher grain volumes without scope for parallel process value-addition during transit.

Also, the contemporary drying processes involves a rough vertical dripping of the grains over hot surfaces or forced air applications with multi-passes resulting in a rough grain handling effect and huge process damages. So, there is a scope and need for a horizontal transit arrangement with controlled smooth handling of grains with parallel process value addition for a compact, efficient and lower handling damages for a higher process yield.

Also, this makes the contemporary conveyors non-compact, bulky, and require large surface area for implementation with a need of a compact system for drying agricultural produce, such as grains, fruits, seeds, vegetables, etc. to be used in grain dryer equipment.

### OBJECT OF THE INVENTION

The object of the invention is to provide a compact conveyor system capable of supporting a parallel process-value-addition during grain transit for an eventual compact dryer equipment design for agricultural produce which has high throughput, excellent process controls, novel process applications on the grains drying like radiant energy, vacuum etc., highly energy efficient due to closed compact dryer construction, lower handling losses and however still less bulky, and requires lesser physical area for implementation.

### SUMMARY OF THE INVENTION

The shortcomings of the prior art are overcome, and additional advantages are provided through the provision of the present disclosure. Additional features and advantages are realized through the techniques of the present disclosure. Other embodiments and aspects of the disclosure are described in detail herein and are considered a part of the disclosure.

The present disclosure focuses on a conveyor system for grains, with capability to support a parallel process by conveying the grains in a controlled manner over a continuous surface with rigid flatbed construction. The system offers a 2-pass movement for an enhanced transit time to fit enough for suitable processing. Particularly, the present disclosure provides series of conveyors, and includes multiple conveyors placed one above the other in a vertical stack-up arrangement/a single conveyor designed in a vertical flow arrangement, to allow serpentine motion of grains. These types of arrangements allow the processing of grains with ease, in minimal time of processing and utilize minimal set-up space.

The conveyor belt includes a plurality of segmental trays built with a rigid material which are placed adjacent to each other fittingly to form a conveyor belt with continuous rigid flat surface, and each of the segmental trays are adapted to tilt on receiving a guiding force. The conveyor system further includes a tilting mechanism which generates the guiding force to tilt the segmental trays. The trays have a surface at edges to closely match the overlapping projection of the adjacent trays. The surface is having a stepped-down geometry at edges to closely match the overlapping projection of the adjacent tray to form an even or a level outer surface along the conveyor's entire construction. The tilting mechanism controls tilting of the trays at least based on location on the belt for tilting the tray, a desired tilt angle by which the tray should be tilted, dwell length to be carried out by the tray while tilting, tilt positions, or combination thereof. The tilt positions can be backward tilt or forward tilt and depends on the profile of the tray.

The tilting of the tray includes tilting the tray to a desired tilt angle from a horizontal position, by carrying out a dwell length while tilting, and further tilting back reversely back to the horizontal position. The tilting mechanism includes a pair of Cam rails, and each tray is fitted with one or more cam shafts, and the cam shafts are further guided in the pair of Cam rail slots. The cam shafts are further guided in the pair of cam rail slots directly or through one or more first bearing arrangements. The cam rail includes a linear or regular profile and a deviation or bent profile, such that wherever the cam rail has a regular profile, the tray is adapted to be in a horizontal position fittingly placed to an adjacent tray, and wherever the cam rail has the deviation profile, the tray is adapted to be in one of a tilted position which is at an angle with respect to the horizontal position. The deviation profile preferably is provided near to extreme end of the conveyor belt.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The novel features and characteristics of the disclosure are set forth in the description The disclosure itself, however, as well as a preferred mode of use, further objectives and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1(a) represents a schematic diagram showing serpentine flow of grains using a single two-pass belt conveyor arrangement, and FIG. 1(b) represents a schematic diagram showing serpentine flow of grains using a vertically stacked two-pass belt conveyor arrangement in accordance with one embodiment of the present disclosure.

FIG. 2 represents perspective view of a conveyor belt having segmental trays with two-pass functionality, in accordance with the embodiments of the present disclosure.

FIG. 3 represents the side view of the conveyor belt, in accordance with the embodiments of the present disclosure.

FIG. 4 represents the perspective view of a segmental tray, in accordance with the embodiments of the present disclosure.

FIG. 5 represents a section of the conveyor system showing a deviation profile of a cam rail, in accordance with the embodiments of the present disclosure.

The figures depict embodiments of the disclosure for purposes of illustration only. One skilled in the art will readily recognize from the following description that alternative embodiments of the assemblies, structures and methods illustrated herein may be employed without departing from the principles of the disclosure described herein.

### DETAILED DESCRIPTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present invention will be described below in detail with reference to the accompanying figures.

The system, methods, and examples provided herein are only illustrative and not intended to be limiting.

The present disclosure focuses on a novel conveyor system for transit of the grains to be able to perform process-value-addition during its transit, comprising series of conveyors which are placed one above the other in a vertical stack-up arrangement, to allow serpentine motion of agricultural produce. In one embodiment, only one conveyor may be sufficient, if only two passes of flow of the agricultural produce is sufficient for drying of agricultural produce. Single conveyor may be sufficient in specific scenario where the conveyor belts are long, or a particular produce may not require long time for drying, or if there are enhanced heading mechanisms to achieve heating of the agricultural produce in lesser time. Number of conveyor belts to be stacked up, can be decided based on specific throughput requirements of a factory/mill operator, or specific to a particular type of agricultural produce, or the heating arrangements to be used. These types of arrangements allow the processing of grains with ease, and utilize minimal set-up space with maximum process value-additions.

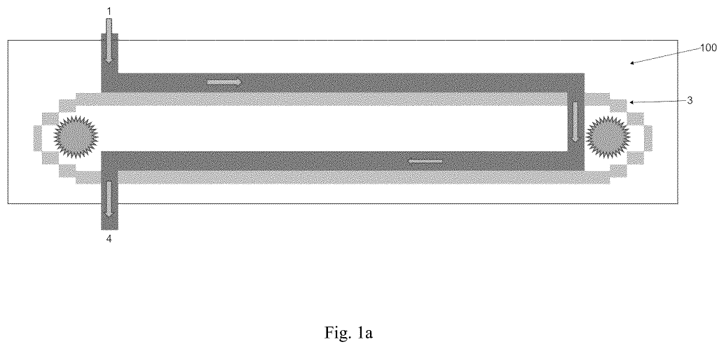

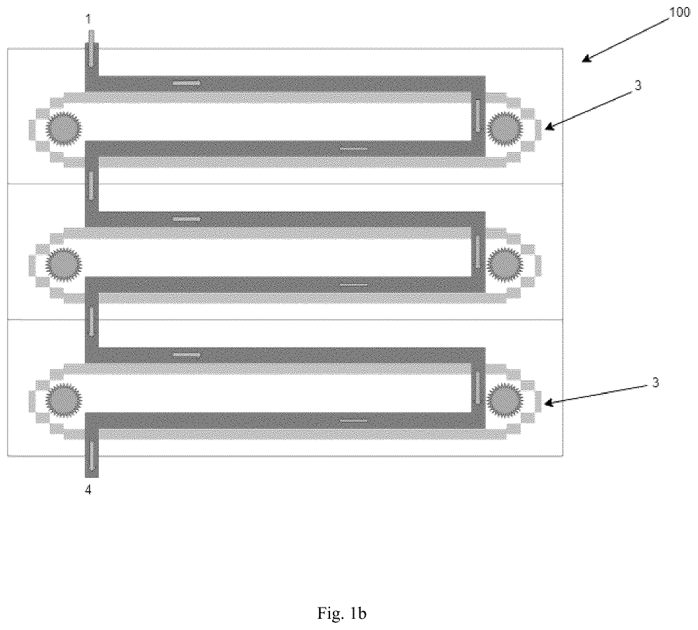

FIG. 1(a) depicts the concept of the 2-pass conveyor system (100) wherein the grain is fed in (1) to the conveyor and the grain is fed out (2) of the conveyor in identical fashion to be in one vertical position in this arrangement. The conveyor has 2 pass capability to move the grains (5) both in forward and reverse directions. The grain bed is formed over the conveyor in both the traverse directions. The grain (5) is made to fall from the top conveyor to the bottom conveyor at the end of its linear traverse and before the commencement of the circular path. The grain (5) falls by gravity on to its below conveyor pass layer. The Novelty of this invention is to give the conveyor the ability to drop the grain (5) to the below conveyor pass while still traversing through its path.

FIG. 1(b) depicts the concept of a series of Conveyors deployed in vertical stack-up configuration to form a continuous functional unit of conveyor system (100) wherein the conveyors are placed one over the other in a symmetric fashion to match the grain-in (1) and grain-out (2) positions of all the conveyors to be in one vertical position only. All vertical drops are gravitational and are aligned through-out this arrangement. The grains (5) fall identically to the conveyor pass positioned below itself whether it is from the same conveyor or the next one, without any difference.

The concept is to drop the grain at the far end of the linear path and before the commencement of the circular path to fully utilize the overall linear path traverse length of the grain passage for maximum in-process value addition potential. This possibility will open up a lot of potential for a compact conveyor arrangement that could be deployed in various processing industries particularly agriculture produce while having to benefit the compact nature of such an equipment design.

The conveyor system (100) is a rigid flatbed surface, continuous flow conveyor system (100) with tilt-able segmental tray (2) construction. The conveyor system (100) includes a rigid flatbed base indicating an unbending and stiff conveyor surface with a flatbed construction for grain holding & movement unlike other flexible material (e.g. PU material, rubber etc.) based conventional conveyor belt (3) or conveyor bases in use, which have bending capabilities. This rigidity & flatness feature is because the conveyor uses a series of trays (2) which are built with either metallic or non-metallic rigid materials like SS, MS, Al, Wood, Hylam, Plastics etc. These solid material-based constructions provide a rigid flat loading surface to the grains which in-turn enables to maintain a uniform distance between the grain top surface & the top located heat emitting source. This can be significant when the heating source is located above the conveyor surface. It can be still more significant when radiant/IR heaters are used for drying applications which needs uniform PEG gap.

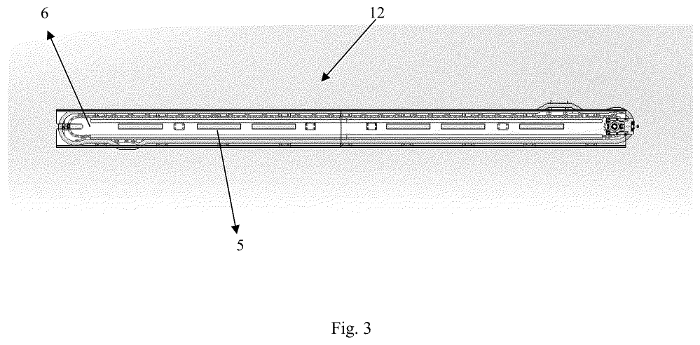

The conveyor system (100) includes a continuous flow design which indicates that it has a continuous base surface without any surface discontinuities over the entire linear path of the tray (2) travel without any spillage gaps, either within or between the trays (2). This eliminates any scope of accidental and undesired spillage of the loaded grain content over the conveyor during its operation. This is achieved by the unique overlap design of the tray arrangement, as shown in FIG. 3, with each tray (2) having a stepped-down surface at edges (10) to closely match the overlapping projection (9) of the adjacent tray (11) to form an even or a level outer surface along the conveyor's entire construction.

In an embodiment, a closed side wall arrangement is provided on either side of the conveyor ends, with a unique design to achieve a zero spill-gap at the sides too. So, this provides a complete box-like enclosure for the grain over the conveyor all along its traverse length and prevents any accidental spillage of the grains during it's in-process transit.

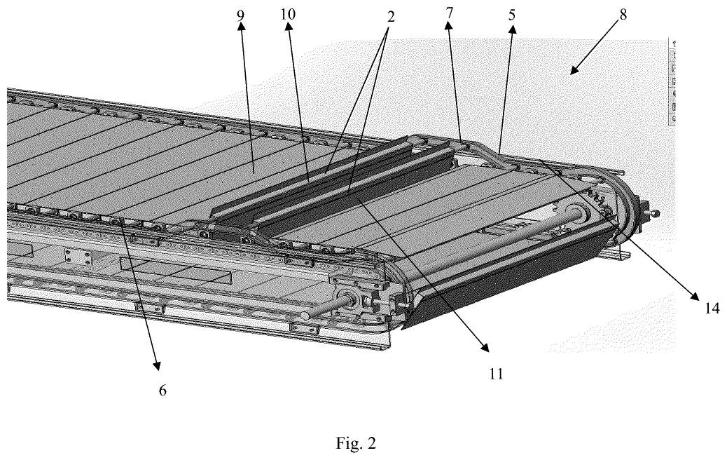

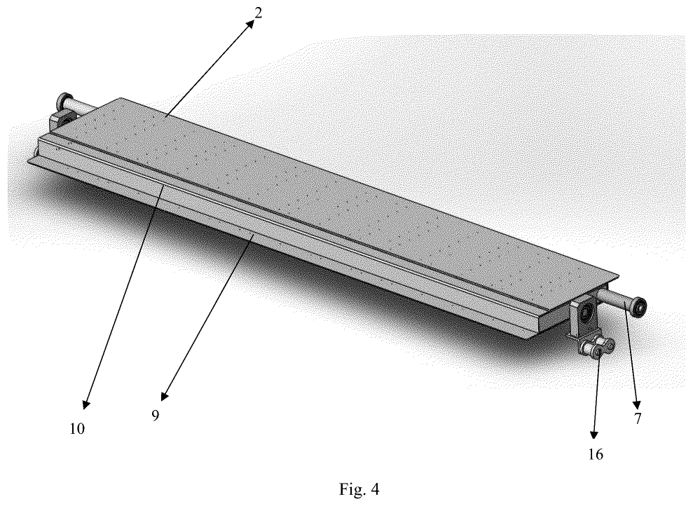

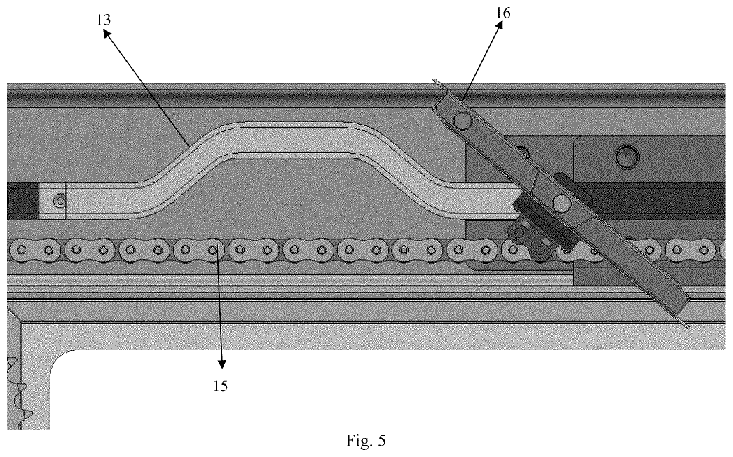

The conveyor system (100) further includes segmental tilting mechanism (8) (as depicted in FIG. 4), represented by FIG. 2, which ensures that the individual segmental trays (2) are able to have a controlled tilt capability at pre-desired locations, tilt angles, dwell lengths and tilt positions as needed for the specific purpose of conveyor usage. The tilting mechanism comprises cam shafts (7), which are further guided in a pair of Cam rail slots (5) through one or more first bearing arrangements. Each tray is fitted with a pair of cam shafts (7), one cam shaft (7) at either edges of the trays, and the shafts are further guided in the pair of cam rail slot (5). The cam rail (6) comprises a regular profile (12) and a deviation profile (13), such that wherever the cam rail (6) has a regular profile (12), the tray is adapted to be in a horizontal position fittingly placed to an adjacent tray (11), and wherever the cam rail (6) has the deviation profile (13), the tray is adapted to be in one of a tilted position which is at an angle with respect to the horizontal position. The deviation profile (13) can either bow upward to the regular profile (12) or bow downward with respect to the regular profile (12), wherein the deviation profile (13) is provided near to extreme end (14) of the conveyor belt (3). FIG. 3 represents a regular cam profile (12), while deviation profile (13) is clearly depicted in FIG. 5.

The tilting mechanism (8) is adapted to control tilting of the trays based on location on the belt (3), a desired tilt angle by which the tray should be tilted, dwell length to be carried out by the tray (2) while tilting, tilt positions, or combination thereof, wherein the tilt positions can be backward tilt or forward tilt and depends on the profile of the tray (2). The tilting of the tray comprises tilting the tray to a desired tilt angle from a horizontal position, by carrying out a dwell length while tilting, and further tilting reversely back to the horizontal position.

Therefore, every segmental tray, with the cam shaft (7) attached, would therefore perform this controlled tilt on arriving at these cam rail slot tilt locations. This feature is normally used to offload the grain/produce being conveyed at a specific offload path stretch or position. This tilting mechanism (8) could be adapted on any conveyor drive mechanisms like sprocket and chain driven, screw type, electrically driven and the like.

In one embodiment, the tilting mechanism (8) may be based on any technology other than the technology explained above. For example, the tilting mechanism (8) may be based on electromagnetism, wherein the trays are tilted automatically by virtue of electromagnetic force being applied on them or air-pressure mechanisms etc.

In one embodiment, the segmental trays (2) are placed side to side instead of overlapping, such that no space is left in between the segmental trays. This may be possible by providing alternate male-female provisions on the sides of each segmental tray, or by any other possible constructional aesthetics.

The conveyor system (100) further includes two-pass feature, which is the result of the combination of above individual mechanisms and arrangements wherein the grain gets conveyed on the top surfaces of both the top and bottom beds of the conveyors. The grain would move over the top conveyor path and get passed on to the bottom conveyor path subsequently and move in backward direction to achieve this two-pass phenomenon. The two-pass conveyor arrangement results in doubling the available grain holding volume and doubling the grain holding time in the same drying environment space. This allows the drying process curves to be quite smooth & highly efficient, in order to affect the best process/drying Quality characteristics on the produce. The two-pass conveyor thus renders the conveyor pass time to half as that needed in a 1-pass conveyor, resulting in doubling the output capacity also. This leads to a more compact equipment design with energy conservations and higher efficiency, better operability and minimum space consumptions and hence higher yield of the processed produce. In conjunction with the modular design, when deployed in serial production arrangement, the overall capacity would simply augment depending on no. of modules thus stacked vertically, while providing even smoother drying process curves and versatility to handle any type of produce in the same arrangement which is quite unique unlike the contemporary designs.

The cam rails (6) are provided with two deviation profiles (13), each placed on each conveying path of the conveyor belt (3) near to two extreme opposite ends of the conveyor belt (3). The conveyor belt (3) comprises a driving mechanism functionally coupled to the trays (2) for driving the trays (2) along a conveying path, wherein the driving mechanism comprises a chain link (15) which is adapted to move on the conveying path, and due to the movement of the chain link (15), the trays (2) are adapted to move onto the conveying path. The driving mechanism comprises one or more mounting shafts (16) functionally coupled to the chain link (15) for driving the trays (2). The driving mechanism also comprises second bearing arrangement(s) (20) which are physically coupled to one or more mounting shafts (16), and to the chain link (15), and is adapted to facilitate rotation of tray (2) while tilting and/or reverse tiling of the tray (2) is being carried out during its transit.

In an embodiment, conveyor system (100) comprises a pair of side walls placed adjacent to either side of the conveyor ends with a minimal gap less than a size of the object to be conveyed through the conveyor belt (3) to prevent side-wards spillage. The conveyor system (100) comprises a brushing arrangement between the walls and the conveyor belt surface (3).

FIG. 2 represents a schematic representation of conveyor belt (3). The conveyor system (100) is a rigid flatbed surface that was achieved by use of Stainless-steel metal construction for trays (2) and using a segmental design with overlap rigid flaps at adjoining tray (2) ends in order to provide a continuous working surface. Even though Stainless Steel is the preferred construction material for the trays (2) in this instance. However, it is possible to use any solid material (metallic & non-metallic) using this design concept. The rigid flatbed is needed to maintain a uniform bed thickness over the conveyor for uniform drying results, upon IR heat dissipation from a specific Product to Emitter Gap (PEG) distance apart from being able to have the requisite strength characteristics of the used material.

The conveyor system (100) arrangement is supplemented by a unique design of side walls provided on either side of the conveyors to prevent spillage from the sides to box-in the grain to avoid sideward spillages. The close flatness of the conveyor top enables to maintain requisite close gap with the side walls, which is also a unique design & construction arrangement feature of this conveyor. A skirting with a suitable brush like arrangement is also provided to enhance the non-spillage or grain containment performance of the conveyor.

The major advantage of the present disclosure is that it requires a relatively smaller space than the contemporary designs which use multiple passes silos type design of driers. The advantages of having a modular design and construction is observed in terms of ease of manufacturing, handling and transport, quick erections and ease of serviceability. It also helps in replicating best practices across modules and helps to render continuous movement of grains in an overall compact unit. Further, the serpentine movement capabilities of conveyor system (100) enable sufficient processing of grains in one overall process systematically and consistently. The two-pass feature offers double the work area and process time capabilities per conveyor as compared to the single-pass conveyors adding to the compactness, efficiency, possibility and adequacy to be used in the drying applications and the like.

The net effect of all the above features of this conveyor is that it enables the process value-addition during grain transit itself resulting in a very compact & energy efficient drier equipment in a modular design & most importantly actually makes the use of IR heating feasible with proper PEG positioning, unlike other conveyor designs. This modular design of the driers enables the use of multiple modules in a vertical stack-up configuration having identical drop-in & drop-out points with capabilities of simultaneous functioning of the assembled modules in a coordinated way as a one single-unit. The rigid flatbed was designed with intent to have a have a solid rigid surface which remained flat all through the linear path of traverse of the conveyor to primarily ensure the uniformity of the PEG gap area for uniform heating of the grains when used in an IR heating and drying applications. In one embodiment, this is achieved by use of Stainless-steel metal construction for trays and using a segmental design with overlap rigid flaps at adjoining tray (2) ends in order to provide a continuous working surface. In another embodiment even though, Stainless Steel is used as the construction material for the trays (2) in this instance, it is possible to use any solid material (metallic & non-metallic) using this design concept. The rigid flatbed is needed to maintain a uniform bed thickness over the conveyor for uniform drying results, upon IR heat dissipation from a specific Product to Emitter Gap (PEG) distance.

### Equivalents

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

### LIST OF REFERRAL NUMERALS

1—Grain in movement
2—Segmental trays
3—Conveyor belt(s)
4—Grain out movement
5—Cam rail slot
6—Cam rail
7—Cam shaft
8—Tilting Mechanism
9—Overlapping projection
10—Stepped-down surface at the edges
11—Adjacent tray
12—Regular profile of cam rail
13—Deviation profile of cam rail
14—Extreme end of the conveyor belt
15—Chain Link
16—Mounting Shaft

1. A conveyor system (100) comprising:
a conveyor belt (3) comprising a plurality of segmental trays (2) which are placed adjacent to each other so fittingly to form a continuous surface, and each of the segmental trays (2) are adapted to tilt on receiving a guiding force;
a tilting mechanism (8) adapted to generate the guiding force to tilt the segmental trays (2).

2. The conveyor system (100) according to the claim 1, wherein the trays (2) are placed overlappingly onto each other to form the conveyor belt (3).

3. The conveyor system (100) according to the claim 2, wherein the trays (2) have a surface at edges to closely match the overlapping projection (9) of the adjacent tray (11).

4. The conveyor system (100) according to claim 3, wherein the trays (2) have a stepped-down surface at edges (10) to closely match the overlapping projection (9) of the adjacent tray (11) to form an even or a level outer surface along the conveyor's (100) entire construction.

5. The conveyor system (100) according to the claim 1, wherein the tilting mechanism (8) is adapted to control tilting of the trays (2) at least based on location on the belt (3) for tilting the tray (2), a desired tilt angle by which the tray (2) should be tilted, dwell length to be carried out by the tray (2) while tilting, tilt positions, or combination thereof, wherein the tilt positions can be backward tilt or forward tilt and depends on the profile of the tray (2).

6. The conveyor system (100) according to the claim 1, wherein the tilting of the tray (2) comprises tilting the tray (2) to a desired tilt angle from a horizontal position, by carrying out a dwell length while tilting, and further tilting back reversely back to the horizontal position.

7. The conveyor system (100) according to the claim 1, wherein the tilting mechanism (8) comprises a pair of Cam rails (6), and each tray (2) is fitted with one or more cam shafts (7), and the cam shafts (7) are further guided in the pair of Cam rail slots (5).

8. The conveyor system (100) according to the claim 7, wherein the cam shafts (7) are further guided in the pair of Cam rail slots (5) through one or more first bearing arrangements.

9. The conveyor system (100) according to the claim 7, wherein each tray is fitted with a pair of cam shafts (7), one cam shaft (7) at either edges of the trays, and the shafts are further guided in the pair of Cam rails slot (5).

10. The conveyor system (100) according to the claim 7 wherein the cam rail (6) comprises a regular profile (12) and a deviation profile (13), such that wherever the cam rail (6) has a regular profile (12), the tray is adapted to be in a horizontal position fittingly placed to an adjacent tray (11), and wherever the cam rail (6) has the deviation profile (13), the tray is adapted to be in one of a tilted position which is at an angle with respect to the horizontal position.

11. The conveyor system (100) according to the claim 10, wherein the deviation profile (13) can either bow upward to the regular profile (12) or bow downward with respect to the regular profile (12).

12. The conveyor system (100) according to the claim 10, wherein the deviation profile (13) is provided near to extreme end (14) of the conveyor belt (3).

13. The conveyor system (100) according to the claim 10, wherein the cam rails (6) are provided with two deviation profile (13), each placed on each conveying path of the conveyor belt (3) near to two extreme opposite ends of the conveyor belt (3).

14. The conveyor system (100) according to the claim 1, wherein the conveyor belt (3) comprises a driving mechanism functionally coupled to the trays for driving the trays along a conveying path.

15. The conveyor system (100) according to claim 14, wherein the driving mechanism comprises a chain link (15) which is adapted to move on the conveying path, and due to the movement of the chain link (15), the trays are adapted to move onto the conveying path.

16. The conveyor system (100) according to the claim 15, wherein the driving mechanism comprises one or more mounting shafts (16) functionally coupled to the chain link (15) for driving the trays.

17. The conveyor system (100) according to the claim 16, wherein the driving mechanism comprising one or more second bearing arrangement (20) which are physically coupled to one or more mounting shafts (16), and to the chain link (15), and is adapted to facilitate rotation of tray while tilting and/or reverse tiling of the tray is being carried out.

18. The conveyor system (100) according to the claim 1 comprising:
a pair of side walls placed adjacent to either side of the conveyor ends with a minimal gap less than a size of the object to be conveyed through the conveyor belt (3) to prevent sidewards spillage.

19. The conveyor system (100) according to the claim 18 comprising:
a brushing arrangement between the walls and the conveyor belt (3).
